(19) United States
(12) Patent Application Publication
(10) Pub. No.: US 2008/0128233 A1
(43) Pub. Date: Jun. 5, 2008

(54) Selectable Mode Clutch

(76) Inventors: Mark A. Joki, Dover, OH (US); Richard F. Murphy, Torrington, CT (US)

Correspondence Address: MICHAEL BEST & FRIEDRICH LLP, 100 E WISCONSIN AVENUE, Suite 3300, MILWAUKEE, WI, 53202, US

(21) Appl. No.: 10/566,737

(22) PCT Filed: Sep. 2, 2005
(86) PCT No.: PCT/US05/31688

§ 371 Date: Feb. 1, 2006

Related U.S. Application Data
(60) Provisional application No. 60/607,661, filed on Sep. 7, 2004.

(51) Int. Cl. F16D 41/08

(52) U.S. Cl. 192/45.1

(57) ABSTRACT

A selectable mode clutch includes a first race coupled for rotation with an input member, a second race, and a projection integrally formed with one of the first and second races. The clutch includes rollers that engage axial ridges on the first and second races to radially displace the second race relative to the first race upon relative rotation between the first race and the second race. The clutch also includes a control member having a first receiving portion and a second receiving portion. One of the control member and the projection is movable along the central axis relative to the other between a first position, in which the projection is positioned in the first receiving portion to operate the clutch in a first mode, and a second position, in which the projection is positioned in the second receiving portion to operate the clutch in a second mode.

### RELATED APPLICATIONS

This application claims priority to U.S. Provisional Patent Application No. 60/607,661 filed Sep. 7, 2004, the entire contents of which is hereby incorporated by reference.

### FIELD OF THE INVENTION

The present invention relates to clutches, and more particularly to bi-directional overrunning clutches or selectable mode clutches.

### BACKGROUND OF THE INVENTION

Bi-directional overrunning clutches are commonly used to selectively transfer torque from an input shaft to an output ring. Such clutches commonly include a housing fixed for rotation with the input shaft, and a slipper positioned between the housing and the output ring. The slipper and housing commonly include respective bearing surfaces, upon which a plurality of rollers ride to space the slipper from the housing. The respective bearing surfaces of the slipper and housing define a plurality of undulations or axial ridges against which the rollers wedge during relative movement between the slipper and the housing. When the rollers wedge against the axial ridges on the bearing surfaces, the rollers move the slipper radially outwardly from the housing, causing the slipper to engage the output ring. The output ring then receives torque from the input shaft.

Overrunning clutches are commonly used in automobile automatic transmissions. In such applications, the clutch commonly operates in a “one-way lock” mode. In other words, the direction of torque in a particular gear causes the clutch to be locked and transmit torque to an output member. When a higher gear is desired, a second torque path in the transmission may be engaged which, because of its higher speed, would tend to reverse the direction of torque in the clutch. Since the clutch operates in the “one-way lock” mode, it does not transfer the reversed direction of torque (i.e., the “negative torque”), and the second torque path smoothly takes over the drive torque. To transfer negative torque, a separate plate clutch is commonly utilized in automobile automatic transmissions.

### SUMMARY OF THE INVENTION

The present invention provides, in one aspect, a selectable mode clutch adapted to selectively couple an input member and an output member. The clutch includes a first race coupled for rotation with the input member about a central axis. The first race includes a first bearing surface having a plurality of axial ridges. The clutch also includes a second race having a second bearing surface in facing relationship with the first bearing surface. The second bearing surface also has a plurality of axial ridges. The clutch further includes a projection integrally formed with one of the first and second races and a plurality of rollers positioned between the first and second bearing surfaces. The rollers engage the axial ridges on the first and second bearing surfaces to radially displace the second race relative to the first race upon relative rotation between the first race and the second race. The clutch also includes a control member rotatable about the central axis. The control member includes a first receiving portion and a second receiving portion. One of the control member and the projection is movable along the central axis relative to the other of the control member and the projection between a first position, in which the projection is positioned in the first receiving portion to operate the clutch in a first mode, and a second position, in which the projection is positioned in the second receiving portion to operate the clutch in a second mode different from the first mode.

The present invention provides, in another aspect, an actuator operable to move one of the control member and the projection along the central axis relative to the other of the control member and the projection between a first position, in which the projection is positioned in the first receiving portion to operate the clutch in a first-mode, and a second position, in which the projection is positioned in the second receiving portion to operate the clutch in a second mode different from the first mode.

Other aspects of the invention will become apparent by consideration of the detailed description and accompanying drawings.

### BRIEF DESCRIPTION OF THE DRAWINGS

FIG. 1 is a cross-sectional view of a first construction of a selectable mode clutch of the present invention.

FIG. 2a is a cross-sectional view of the selectable mode clutch of FIG. 1 taken along line 2a-2a, illustrating a plurality of rollers in a neutral, non-jammed configuration.

FIG. 2b is a cross-sectional view of the selectable mode clutch of FIG. 1 taken along line 2b-2b, illustrating the plurality of rollers in a jammed configuration.

FIG. 3 is a side view of a portion of the selectable mode clutch of FIG. 1, illustrating the clutch in a first mode of operation.

FIG. 4 is a side view of a portion of the selectable mode clutch of FIG. 1, illustrating the clutch in a second mode of operation.

FIG. 5 is a cross-sectional view of a second construction of a selectable mode clutch of the present invention.

FIG. 6 is a cross-sectional view of a third construction of a selectable mode clutch of the present invention.

FIG. 7a is a top perspective view of a portion of the selectable mode clutch of FIG. 6, illustrating a control member in a first position to operate the clutch in a first mode of operation.

FIG. 7b is a top perspective view of a portion of the selectable mode clutch of FIG. 6, illustrating the control member in a second position to operate the clutch in a second mode of operation.

FIG. 7c is a top perspective view of a portion of the selectable mode clutch of FIG. 6, illustrating the control member in a third position to operate the clutch in a third mode of operation.

FIG. 7d is a top perspective view of a portion of the selectable mode clutch of FIG. 6, illustrating the control member in a fourth position to operate the clutch in the first mode of operation.

FIG. 8a is a top perspective view of an alternate construction of the control member of FIGS. 7a-7d, illustrating the control member in the first position to operate the clutch in the first mode of operation.

FIG. 8b is a top perspective view of the control member of FIG. 8a, illustrating the control member in the second position to operate the clutch in the second mode of operation.

FIG. 8c is a top perspective view of the control member of FIG. 8a, illustrating the control member in the third position to operate the clutch in the third mode of operation.

FIG. 8d is a top perspective view of the control member of FIG. 8a, illustrating the control member in the fourth position to operate the clutch in the first mode of operation.

FIG. 9 is a cross-sectional view of a fourth construction of a selectable mode clutch of the present invention.

FIG. 10a is a cross-sectional view of a portion of the selectable mode clutch of FIG. 9, illustrating a control member in a first position to operate the clutch in a first mode of operation.

FIG. 10b is a cross-sectional view of a portion of the selectable mode clutch of FIG. 9, illustrating the control member in a second position to operate the clutch in a second mode of operation.

FIG. 11 is a cross-sectional view of a fifth construction of a selectable mode clutch of the present invention.

FIG. 12a is a cross-sectional view of a portion of the selectable mode clutch of FIG. 11, illustrating a control member in a first position to operate the clutch in a first mode of operation.

FIG. 12b is a cross-sectional view of a portion of the selectable mode clutch of FIG. 11, illustrating the control member in a second position to operate the clutch in a second mode of operation.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

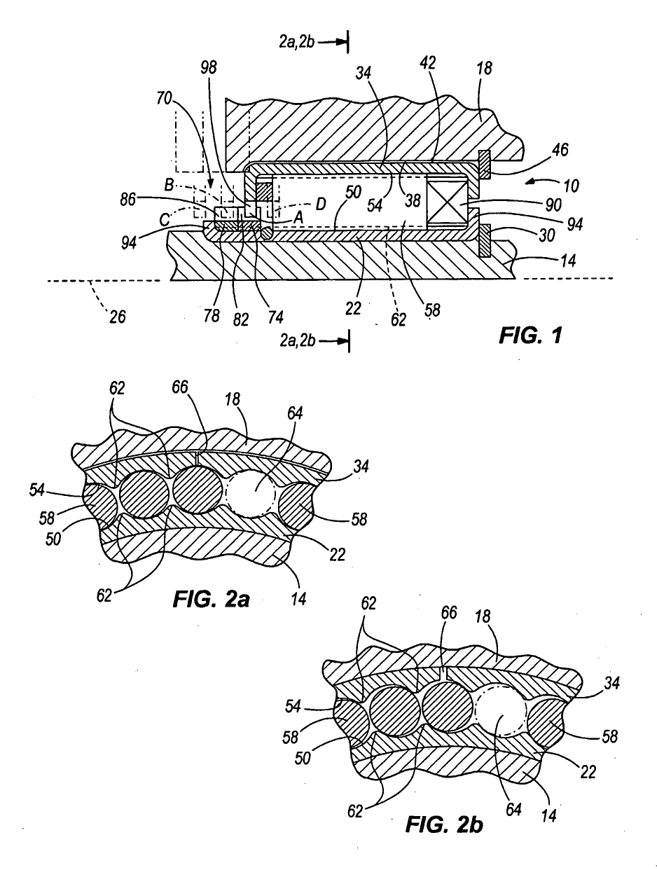

FIGS. 1-4 illustrate a first construction of a bi-directional overrunning clutch or a selectable mode clutch 10 configured to selectively transfer torque from an input member 14 to an output member 18. With reference to FIG. 1, the clutch 10 includes an inner race 22 coupled for rotation with the input member 14 (e.g., a shaft) about a central axis 26. In the illustrated construction, the inner race 22 is press-fit on the input member 14 to axially restrain the inner race 22 relative to the input member 14. Alternatively, a retainer 30 may be used to provide additional axial restraint to the inner race 22. The clutch 10 also includes an outer race 34, which is located radially outward from the inner race 22. The outer race 34 is fitted loosely into a bore 38 of the output member 18 (e.g., an outer ring), such that an outer surface 42 of the outer race 34 may be spaced from or loosely engaging the output member 18. Another retainer 46 may be used to provide axial restraint to the outer race 34 relative to the output member 18.

The inner and outer races 22, 34 include respective bearing surfaces 50, 54 upon which a plurality of rollers 58 contact. With reference to FIG. 2a, the respective bearing surfaces 50, 54 define a plurality of undulations or axial ridges 62 that form pockets 64 into which individual rollers 58 are positioned. Alternatively, the pockets 64 may be configured to receive more than one roller 58, and the axial ridges 62 that form the pockets 64 may be configured to be more or less inclined than the axial ridges 62 shown in FIG. 2a.

Also, as shown in FIG. 2a, the outer race 34 is not a continuous member. Rather, the outer race 34 includes an axial cut or slit 66 that allows the outer race 34 to expand radially outwardly when forces act upon the bearing surface 54 of the outer race 34.

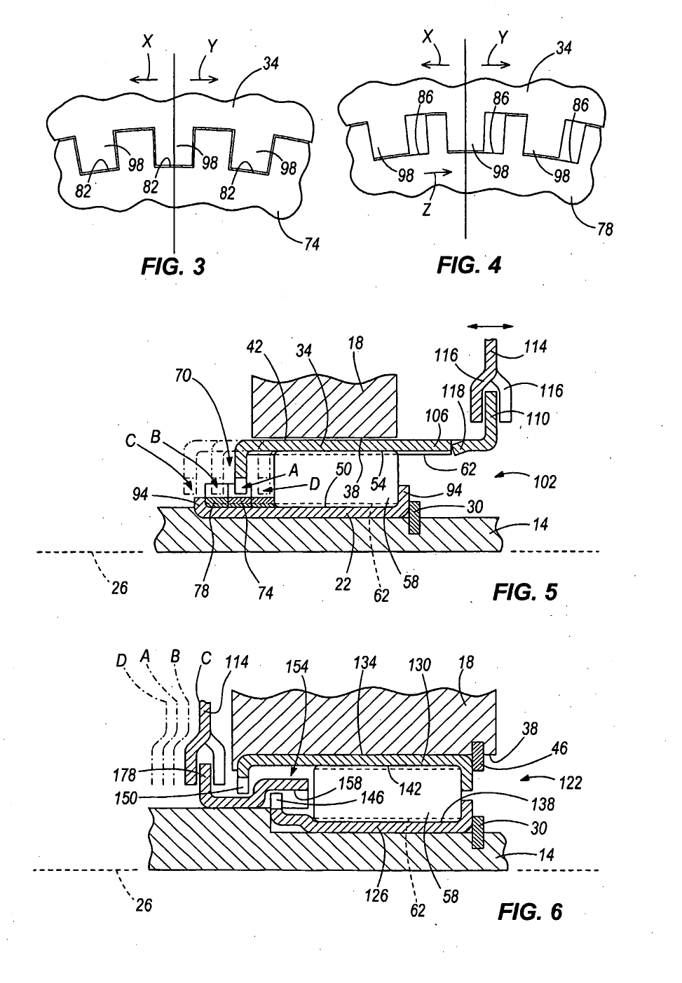

With reference to FIG. 1, a control member 70 is coupled for rotation with the inner race 22. In the illustrated construction, the control member 70 is configured as two distinct control rings 74, 78 that are rotationally fixed to the inner race 22 at one end. As shown in FIG. 3, the control ring 74 includes a plurality of radially outward-extending projections that define therebetween a plurality of receiving portions or slots 82. As shown in FIG. 4, the other control ring 78 includes a plurality of radially outward-extending projections that define therebetween a plurality of receiving portions or slots 86. Comparing the slots 82, 86 in the two control rings 74, 78, the slots 86 in the control ring 78 are wider than the slots 82 in the control ring 74. Alternatively, the control rings 74, 78 may only each include a single slot 82, 86, rather than a plurality of slots 82, 86. While the control rings 74, 78 are shown as separate components fixed to the inner race 22, the control rings 74, 78 may be formed integrally as a part of the inner race 22. Additionally, while the control rings 74, 78 are shown as two distinct rings, a single ring having two distinct patterns of slots 82, 86 may also be utilized.

With reference to FIG. 1, the rollers 58 are axially trapped between the control rings 74, 78 at one end and a wave spring 90 at the other end. Flanges 94 on both ends of the inner race 22 trap the control rings 74, 78, the rollers 58, and the wave spring 90 with a slight spring preload. Alternatively, the clutch 10 may incorporate additional structure to reduce axial movement of the rollers 58.

With continued reference to FIGS. 1, 3, and 4, the outer race 34 includes a plurality of integrally-formed, radially inward-extending projections 98 that have a width substantially equal to the width of the slots 82 in the control ring 74 (see FIG. 3). As a result, when the projections 98 are positioned in the slots 82 in the control ring 74, little to no relative movement between the inner race 22 and the outer race 34 is allowed. Since the slots 86 in the control ring 78 are wider than the slots 82 in the control ring 74, some relative movement between the inner race 22 and the outer race 34 is allowed when the projections 98 are positioned in the slots 86 in the control ring 78. Alternatively, the outer race 34 may only include a single radially inward-extending projection 98 to be positioned in one of the slots 82 in the control ring 74 or one of the slots 86 in the control ring 78. Further, alternate embodiments of the clutch 10 may utilize axially-extending projections rather than radially-extending projections 98.

With reference to FIG. 1, the clutch 10 is adjustable between different modes of operation by moving the outer race 34 along the central axis 26 relative to the control member 70. In the illustrated construction, the outer race 34 is moved along the central axis 26 by moving the output member 18 along the central axis 26. Alternatively, the outer race 34 may be movable along the central axis 26 relative to the output member 18.

When the outer race 34 is moved to a position “A” with respect to the control member 70, the clutch 10 is operable in a mode in which the projections 98 are positioned in the slots 82 of the control ring 74 to lock together the inner race 22 and the outer race 34 for co-rotation. The wave spring 90 may be configured to bias the outer race 34 with respect to the control member 70 such that the projections 98 are retained in position A. Alternatively, the wave spring 90 may be configured to bias the outer race 34 with respect to the control member 70 in a different position other than position A.

When the outer race 34 is moved to a position “B” relative to the control member 70, the clutch 10 is operable in a different mode in which the projections 98 are positioned in the slots 86 of the control ring 78 to allow the inner race 22 to rotate about the central axis 26 in a single direction relative to the outer race 34. Further, when the outer race 34 is moved to either positions “C” or “D,” which are the outermost positions along the central axis 26 relative to the control member 70, the clutch 10 is operable in yet another mode in which the projections 98 are positioned outside the axial extents of the respective slots 82, 86, such that the inner race 22 is rotatable about the central axis 26 in any direction relative to the outer race 34.

With reference to FIG. 3, the clutch 10 is shown in the mode of operation corresponding with position A of the outer race 34, in which the projections 98 are positioned in the slots 82 in the control ring 74. As a result, there is little to no rotational movement between the inner race 22 and the outer race 34, in either of the rotational directions indicated by arrows “X” or “Y.” With little to no rotational movement between the inner race 22 and the outer race 34, the rollers 58 maintain a neutral, non-jamming configuration in the pockets 64 between the inner race 22 and the outer race 34. Therefore, the outer race 34 is prevented from moving radially outwardly and engaging the output member 18 to transfer torque from the input member 14 to the output member 18. Rather, the inner race 22 and outer race 34 rotate together and the outer surface 42 of the outer race 34 slips within the bore 38 of the output member 18. This mode of operation of the clutch 10 may be referred to as the “freewheel” mode or “no lock” mode because clutch 10 will not “lock” together the input member 14 and output member 18, no matter the direction of rotation of the input member 14.

With reference to FIG. 4, the clutch 10 is shown in the mode of operation corresponding with position B of the outer race 34, in which the projections 98 are positioned in the slots 86 of the control ring 78. Also, as shown in FIG. 4, the rollers 58 are in their neutral, non-jamming configuration in the pockets 64 such that the outer race 34 is not moved radially outwardly. Frictional drag between the outer race 34 and the output member 18 causes the projections 98 to move in the slots 86 in the control ring 78 in the direction indicated by arrow “Z” when the inner race 22 is rotated in the direction indicated by arrow X relative to the outer race 34. Therefore, the inner race 22 is allowed to rotate relative to the outer race 34 when the inner race 22 is rotated in the direction indicated by arrow X. Particularly, when the inner race 22 rotates relative to the outer race 34, the rollers 58 jam against the ridges 62 on the respective bearing surfaces 50, 54 (see FIG. 2b). This displaces the rollers 58 radially outwardly from the inner race 22, such that each of the rollers 58 applies a force to the bearing surface 54 of the outer race 34. These forces on the bearing surface 54 cause the outer race 34 to expand radially outwardly, as provided by the axial cut or slit 66 in the outer race 34, such that the outer surface 42 of the outer race 34 engages the output member 18 to transfer torque from the input member 14 to the output member 18.

However, with reference to FIG. 4, the projections 98 are prevented from moving in the slots 86 in the direction indicated by arrow Z when the inner race 22 is rotated in the direction indicated by arrow Y relative to the outer race 34. Therefore, little to no rotational movement occurs between the inner race 22 and outer race 34, and the rollers 58 maintain their neutral, non-jammed configuration in the pockets 64 between the inner race 22 and the outer race 34. Therefore, as described above, the outer race 34 is prevented from moving radially outwardly and engaging the output member 18 to transfer torque from the input member 14 to the output member 18. This mode of operation of the clutch 10 may be referred to as the “one-way lock” mode because the clutch 10 will “lock” together the input member 14 and the output member 18 if the input member 14 is rotated in one direction about the central axis 26 (e.g., the direction indicated by arrow X), but will not “lock” together the input member 14 and the output member 18 if the input member 14 is rotated in the opposite direction about the central axis 26 (e.g., the direction indicated by arrow Y).

With reference to FIG. 1, the clutch 10 may be adjusted to yet another mode of operation by moving the outer race 34 to either of the outermost positions C or D, in which the projections 98 are free of any engagement with the slots 82, 86 in the control rings 74, 78. As a result, the inner race 22 is allowed to rotate relative to the outer race 34 when the inner race 22 is rotated in either of the directions indicated by arrows X or Y, as shown in FIGS. 3 and 4. As described above, when the inner race 22 rotates relative to the outer race 34, the rollers 58 jam against the ridges 62 on the respective bearing surfaces 50, 54 and expand the outer race 34 radially outwardly, such that the outer surface 42 of the outer race 34 engages the output member 18 to transfer torque from the input member 14 to the output member 18 (see FIG. 2b). This mode of operation of the clutch 10 may be referred to as the “two-way lock” or “full lock” mode because the clutch 10 will “lock” together the input member 14 and the output member 18 if the input member 14 is rotated in any direction about the central axis 26 (e.g., the directions indicated by arrows X and Y in FIGS. 3 and 4).

With reference to FIG. 5, a second construction of a bi-directional overrunning or selectable mode clutch 102 is shown. The clutch 102 of FIG. 5 is substantially similar to the clutch 10 of FIGS. 1-4, both structurally and functionally. As such, like components are labeled with like reference numerals and will not be discussed again in detail. However, the clutch 102 of FIG. 5 includes an outer race 106 having a radially outward-extending flange 110. The output member 18 and the inner race 22 are fixed axially relative to the input member 14, and a shifter fork 114 is operable to move the outer race 106 along the central axis 26 relative to the control member 70. The shifter fork 114 may be made from sheet stock having stamped tabs 116 for axially containing the flange 110. A tab 118 extending inwardly from the outer race 106 may prevent the clutch 102 from falling apart during handling operations.

During operation of the clutch 102 of FIG. 5, a motor or solenoid may be used to move the shifter fork 114 along the central axis 26. The shifter fork 114, in turn, moves the outer race 106 to positions A, B, C, or D to operate the clutch 102 in one of the no-lock, one-way lock, or full-lock modes. Although not shown in FIG. 5, a spring similar to the wave spring 90 in the clutch 10 of FIGS. 1-4 may be used to bias the shifter fork 114 and the outer race 106 to one of the positions A, B, C, or D.

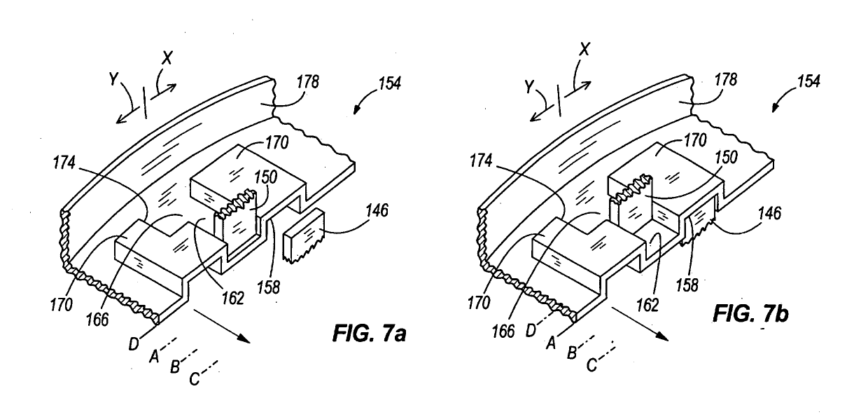

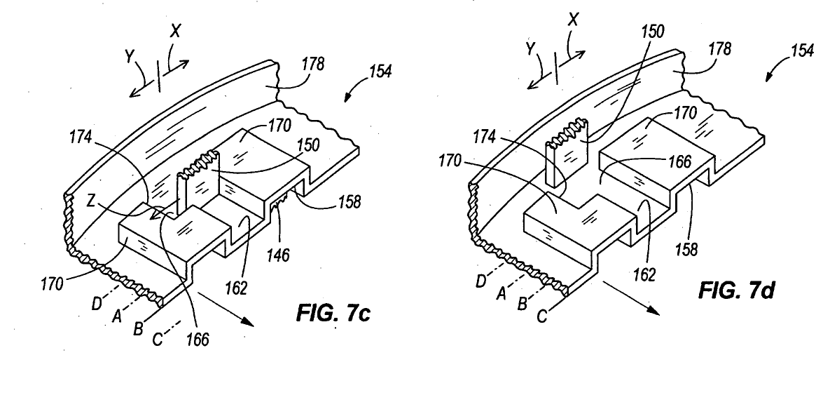

With reference to FIGS. 6-7d, a third construction of a bi-directional overrunning clutch or selectable mode clutch 122 is shown. Portions of the clutch 122 of FIGS. 6-7d are substantially similar to the clutches 10, 102 of FIGS. 1-4 and FIG. 5, respectively. As such, like components are labeled with like reference numerals and will not be discussed again in detail. The clutch 122 includes an inner race 126 coupled for rotation with the input member 14 about the central axis 26. In the illustrated construction, the inner race 126 is press-fit on the input member 14 to axially restrain the inner race 126 relative to the input member 14. The retainer 30 may be used to provide additional axial restraint to the inner race 126. The clutch 122 also includes an outer race 130 fitted loosely into the bore 38 of the output member 18, such that an outer surface 134 of the outer race 130 may be spaced from or loosely engaging the output member 18. Another retainer 46 may be used to provide axial restraint to the outer race 130 relative to the output member 18.

The inner and outer races 126, 130 include respective bearing surfaces 138, 142 substantially similar to the bearing surfaces 50, 54 described above in connection with the clutch 10 of FIGS. 1-4. Also, like the outer race 34 of the clutches 10, 102 of FIGS. 1-5, the outer race 130 is not a continuous member. Rather, the outer race 130 includes an axial cut or slit that allows the outer race 130 to expand radially outwardly when forces act upon the bearing surface 142 of the outer race 130.

With reference to FIGS. 6-7d, the inner race 126 includes at least one radially outward-extending tooth or projection 146, and the outer race 130 includes at least one radially inward-extending tooth or projection 150. In the illustrated construction, the projections 146, 150 are integrally formed with the inner race 126 and the outer race 130, respectively. Alternatively, the projections 146, 150 may be separate and distinct components that are coupled for rotation with the inner race 126 and the outer race 130, similar to the control rings 74, 78 in the clutch 10 of FIGS. 1-4. Further, in alternate embodiments of the clutch 122, the inner and outer races 126, 130 may utilize axially-extending projections rather than radially-extending projections.

With continued reference to FIGS. 6-7d, the clutch 122 includes a control member 154 coupled for rotation with at least one of the inner race 126 and the outer race 130. As shown in FIGS. 7a-7d, the control member 154 includes a plurality of axially directed receiving portions or slots 158, 162, 166 into which the projections 146, 150 may be inserted. Particularly, the slot 158 is configured as a generally rectangular slot 158 for receiving the generally rectangular projection 146 of the inner race 126. Likewise, the slots 162, 166 are configured as generally rectangular slots 162, 166 for receiving the generally rectangular projection 150 of the outer race 130. In the illustrated construction, the slot 162 is defined between adjacent radially outward projections 170. One of the projections 170 has a notched area 174 to provide the wider slot 166 for the projection 150. The control member 154 also includes a radially outward-extending flange 178 which may be engaged by the shifter fork 114 to move the control member 154 along the central axis 26 relative to the inner and outer races 126, 130.

With reference to FIGS. 6-7d, the clutch 122 is adjustable between different modes of operation by moving the control member 154 along the central axis 26 relative to the inner and outer races 126, 130. When the control member 154 is moved to a position “A” relative to the inner and outer races 126, 130, the clutch 122 is operable in a mode in which the projections 146, 150 are positioned in the slots 158, 162 of the control member 154 to lock together the inner race 126 and the outer race 130 for co-rotation (see FIG. 7b).

When the control member 154 is moved to a position “B” relative to the inner and outer races 126, 130, the clutch 122 is operable in a different mode in which the projection 146 on the inner race 126 is positioned in the slot 158 and the projection 150 on the outer race 130 is positioned in the widened slot 166 to allow the inner race 126 to rotate about the central axis 26 in a single direction relative to the outer race 130 (see FIG. 7c). Further, when the control member 154 is moved to either positions “C” or “D,” which are the outermost positions along the central axis 26 relative to the inner and outer races 126, 130, the clutch 122 is operable in yet another mode in which one of the projections 146, 150 is positioned outside the axial extents of the respective slots 158, 162, such that the inner race 126 is rotatable about the central axis 26 in any direction relative to the outer race 130 (see FIGS. 7a and 7d). Although not shown in FIG. 6, a spring similar to the wave spring 90 in the clutch 10 of FIGS. 1-4 may be used to bias the control member 154 with respect to the inner and outer races 126, 130 such that the control member 154 is retained in one of the positions A, B, C, or D.

With reference to FIGS. 6 and 7b, the clutch 122 is shown in the mode of operation corresponding with position A of the control member 154, in which the projections 146, 150 are positioned in the slots 158, 162 in the control member 154. As a result, there is little to no rotational movement between the inner race 126 and the outer race 130, in either of the directions indicated by arrows X or Y. With little to no rotational movement between the inner race 126 and outer race 130, the rollers 58 maintain the neutral, non-jamming configuration as described above. Therefore, the outer race 130 is prevented from moving radially outwardly and engaging the output member 18 to transfer torque from the input member 14 to the output member 18. Rather, the inner race 126 and outer race 130 rotate together and the outer surface 134 of the outer race 130 slips within the bore 38 of the output member 18. As described above, this mode of operation of the clutch 122 may be referred to as the “no lock” mode because clutch 122 will not “lock” together the input member 14 and output member 18, no matter the direction of rotation of the input member 14.

With reference to FIGS. 6 and 7c, the clutch 122 is shown in the mode of operation corresponding with position B of the control member 154, in which the projection 146 on the inner race 126 is positioned in the slot 158 and the projection 150 on the outer race 130 is positioned in the widened slot 166. Frictional drag between the outer race 130 and the output member 18 causes the projection 150 on the outer race 130 to move in the widened slot 166 in the direction indicated by arrow Z when the inner race 126 is rotated in the direction indicated by arrow X relative to the outer race 130. Therefore, the inner race 126 is allowed to rotate relative to the outer race 130 when the inner race 126 is rotated in the direction indicated by arrow X. As described above, the rollers 58 jam against the ridges 62 on the respective bearing surfaces 138, 142 when the inner race 126 rotates relative to the outer race 130. This displaces the rollers 58 radially outwardly from the inner race 126, such that each of the rollers 58 applies a force to the bearing surface 142 of the outer race 130. These forces on the bearing surface 142 cause the outer race 130 to expand radially outwardly, as provided by the axial cut or slit in the outer race 130, such that the outer surface 134 of the outer race 130 engages the output member 18 to transfer torque from the input member 14 to the output member 18.

However, the projection 150 on the outer race 130 is prevented from moving in the slot 166 in the direction indicated by arrow Z when the inner race 126 is rotated in the direction indicated by arrow Y. Therefore, little to no rotational movement occurs between the inner race 126 and the outer race 130, and the rollers 58 maintain the neutral, non-jammed configuration as described above. Therefore, the outer race 130 is prevented from moving radially outwardly and engaging the output member 18 to transfer torque from the input member 14 to the output member 18. As described above, this mode of operation of the clutch 122 may be referred to as the “one-way lock” mode because the clutch 122 will “lock” together the input member 14 and the output member 18 if the input member 18 is rotated in one direction about the central axis 26 (e.g., the direction indicated by arrow X), but will not “lock” together the input member 14 and the output member 18 if the input member 14 is rotated in the opposite direction about the central axis 26 (e.g., the direction indicated by arrow Y).

With reference to FIGS. 6, 7a, and 7d, the clutch 122 may be adjusted to yet another mode of operation by moving the control member 154 to either of the outermost positions C or D, in which one of the projections 146, 150 is positioned outside the axial extents of the respective slots 158, 162. As a result, the inner race 126 is allowed to rotate relative to the outer race 130 when the inner race 126 is rotated in either of the directions indicated by arrows X or Y.

Particularly, as shown in FIG. 7d, the control member 154 is moved to position C to position the projection 150 on the outer race 130 outside the axial extent of the slot 166, while the projection 146 on the inner race 126 is positioned in the slot 158. Upon rotation of the inner race 126 in either of the directions indicated by arrows X or Y, the projection 150 on the outer race 130 is not retained in either of the slots 162, 166. Therefore, frictional drag between the outer race 130 and the output member 18 causes the outer race 130 to rotate relative to the inner race 126, causing the rollers 58 to jam and expand the outer race 130 radially outwardly, such that the outer surface 134 of the outer race 130 engages the output member 18 to transfer torque from the input member 14 to the output member 18.

As shown in FIG. 7a, the control member 154 is moved to position D to position the projection 146 on the inner race 126 outside the axial extent of the slot 158, while the projection 150 on the outer race 130 is positioned in the slot 162. Upon rotation of the inner race 126 in either of the directions indicated by arrows X or Y, the projection 146 is not retained in the slot 158. Therefore, frictional drag between the outer race 130 and the inner race 126 causes the outer race 130 to rotate relative to the inner race 126, causing the rollers 58 to jam and expand the outer race 130 radially outwardly, such that the outer surface 134 of the outer race 130 engages the output member 18 to transfer torque from the input member 14 to the output member 18. As described above, this mode of operation of the clutch 122 (illustrated in both FIGS. 7a and 7d) may be referred to as the “full lock” mode because the clutch 122 will “lock” together the input member 14 and the output member 18 if the input member 14 is rotated in any direction about the central axis 26 (e.g., the directions indicated by arrows X and Y).

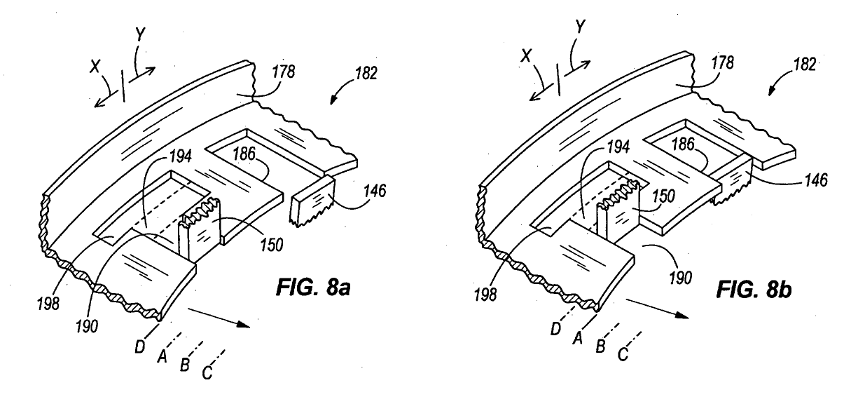

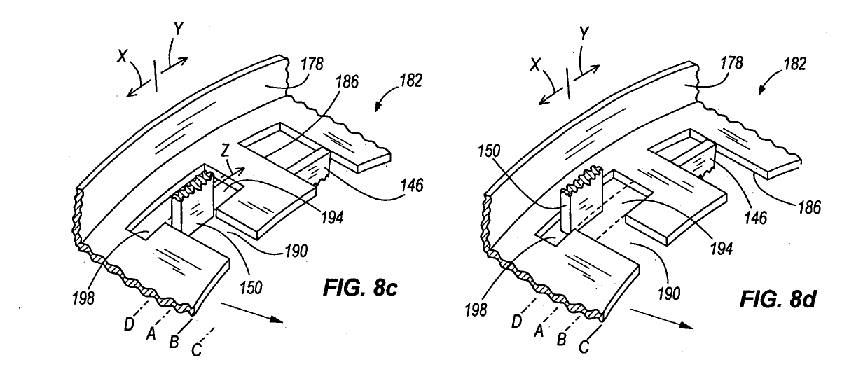

With reference to FIGS. 8a-8d, an alternate construction of a control member 182 is shown. The control member 182 may be used in the clutch 122 of FIG. 6 rather than the control member 154 of FIGS. 7a-7d. As such, like components are labeled with like reference numerals, and the remaining portions of the clutch 122 will not be discussed again in detail. As shown in FIGS. 8a-8d, the control member 182 includes receiving portions or slots 186, 190, 194, 198 configured to receive the projections 146, 150 of the inner race 126 and the outer race 130, respectively. Particularly, the slot 186 is configured as a generally rectangular slot 186 for receiving the generally rectangular projection 146 of the inner race 126. Likewise, the slots 190, 194, 198 are configured as generally rectangular slots 190, 194, 198 for receiving the generally rectangular projection 150 of the outer race 130. The slot 186 has a width substantially equal to the width of the projection 146 on the inner race 126, while the slot 194 is wider than the slot 190, and the slot 198 is even wider than the slot 194. Like the control member 154 of FIGS. 7a-7d, the control member 182 of FIGS. 8a-8d is movable along the central axis 26 relative to the inner and outer races 126, 130 to position A to operate the clutch 122 in the no-lock mode, position B to operate the clutch 122 in the one-way lock mode, and positions C and D to operate the clutch 122 in the full-lock mode. Operation of the control member 182 in no-lock mode, one-way lock mode, and full-lock mode is substantially similar to that of the control member 154 of FIGS. 7a-7d, and will not be discussed again in detail.

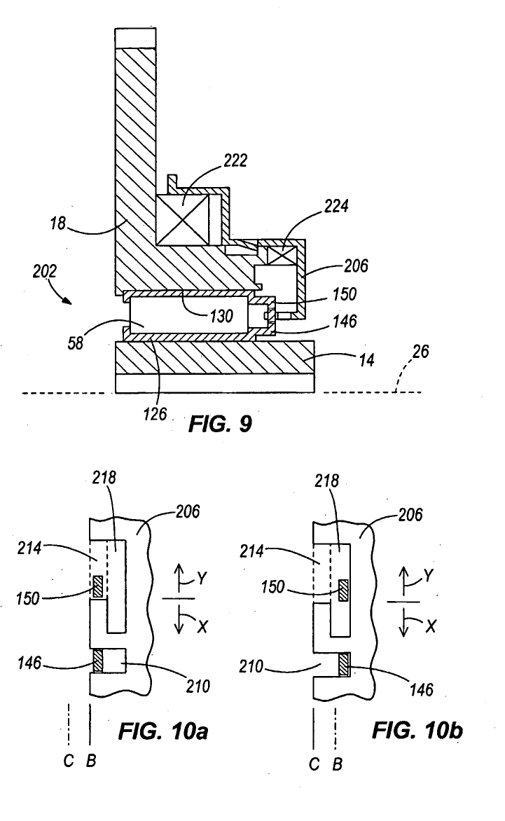

With reference to FIGS. 9-10b, a fourth construction of a bi-directional overrunning clutch or selectable mode clutch 202 is shown. Portions of the clutch 202 of FIGS. 9-10b are substantially similar to the clutches 10, 122 of FIGS. 1-4 and FIGS. 5-8d, respectively. As such, like components are labeled with like reference numerals and will not be discussed again in detail. In the illustrated construction, the clutch 202 is configured as a two-mode clutch for use in an automatic transmission of an automobile. Alternatively, the clutch 202 may be configured as a three-mode clutch.

As shown in FIG. 9, the clutch 202 includes a control member 206 coupled for rotation with the inner race 126. As shown in FIGS. 10a and 10b, the control member 206 includes a plurality of axially directed receiving portions or slots 210, 214, 218 into which the projections 146, 150 may be inserted. Particularly, the slot 210 is configured as a generally rectangular slot 210 for receiving the generally rectangular projection 146 of the inner race 126. Likewise, the slots 214, 218 are configured as generally rectangular slots 214, 218 for receiving the generally rectangular projection 150 of the outer race 130. The slot 210 has a width substantially equal to the width of the projection 146 on the inner race 126, while the slot 214 is wider than the slot 210, and the slot 218 is even wider than the slot 214.

With reference to FIG. 9, the clutch 202 may include a solenoid 222 for moving the control member 206 along the central axis 26 relative to the inner and outer races 126, 130. The solenoid 222 may be de-energized to move the control member 206 to position B relative to the inner and outer races 126, 130 (see FIG. 10a), in which the projection 146 on the inner race 126 is positioned in the slot 210 and the projection 150 on the outer race 130 is positioned in the slot 214 to allow the inner race 126 to rotate about the central axis 26 in a single direction relative to the outer race 130. The solenoid 222 may be energized to move the control member 206 to position C relative to the inner and outer races 126, 130 (see FIG. 10b), in which the projection 150 on the outer race 130 is positioned in the slot 218 to allow the inner race 126 to rotate about the central axis 26 in any direction relative to the outer race 130. Alternatively, the solenoid 222 may be de-energized to move the control member 206 to position C and energized to move the control member 206 to position B. As shown in FIG. 9, a wave spring 224 may be used to bias the control member 206 toward position B with respect to the inner and outer races 126, 130 when the solenoid 222 is de-energized.

The control member 206 is movable along the central axis 26 relative to the inner and outer races 126, 130 to position B to operate the clutch 202 in the one-way lock mode and position C to operate the clutch 202 in the full-lock mode. The interaction of the projections 146, 150 on the inner and outer races 126, 130 and the control member 206 in the one-way lock mode and the full-lock mode is substantially similar to that of the control member 154 of FIGS. 7a-7d and the control member 182 of FIGS. 8a-8d, and will not be discussed again in detail.

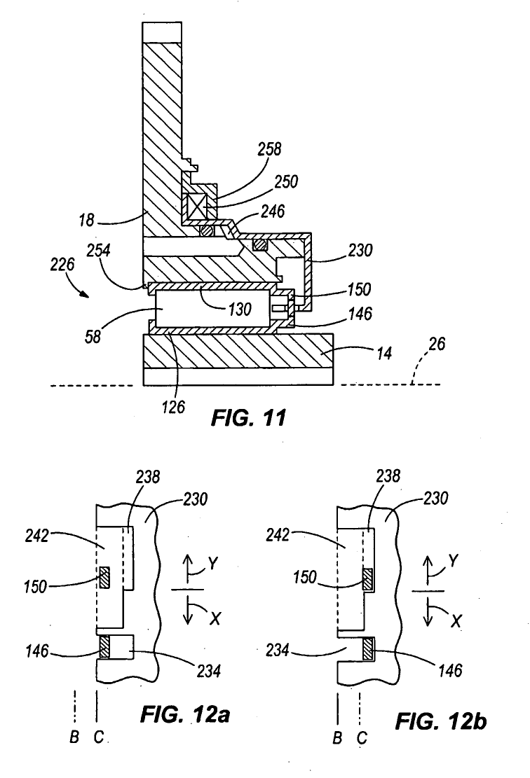

With reference to FIGS. 11-12b, a fifth construction of a bi-directional overrunning clutch or selectable mode clutch 226 is shown. Portions of the clutch 226 of FIGS. 11-12b are substantially similar to the clutches 10, 122, 202 of FIGS. 1-4; FIGS. 5-8d, and FIGS. 9-10b, respectively. As such, like components are labeled with like reference numerals and will not be discussed again in detail.

As shown in FIG. 11, the clutch 226 includes a control member 230 coupled for rotation with the inner race 126. As shown in FIGS. 12a and 12b, the control member 230 includes a plurality of axially directed receiving portions or slots 234, 238, 242 into which the projections 146, 150 may be inserted. Particularly, the slot 234 is configured as a generally rectangular slot 234 for receiving the generally rectangular projection 146 of the inner race 126. Likewise, the slots 238, 242 are configured as generally rectangular slots 238, 242 for receiving the generally rectangular projection 150 of the outer race 130. The slot 234 has a width substantially equal to the width of the projection 146 on the inner race 126, while the slot 238 is wider than the slot 234, and the slot 242 is even wider than the slot 238.

With reference to FIG. 11, the clutch 226 may include a hydraulic chamber 246 for moving the control member 230 along the central axis 26 relative to the inner and outer races 126, 130. The hydraulic chamber 246 may be emptied to move the control member 230 to position B relative to the inner and outer races 126, 130 (see FIG. 12b), in which the projection 146 on the inner race 126 is positioned in the slot 234 and the projection 150 on the outer race 130 is positioned in the slot 238 to allow the inner race 126 to rotate about the central axis 26 in a single direction relative to the outer race 130. The hydraulic chamber 246 may be filled and expanded to move the control member 230 to position C relative to the inner and outer races 126, 130 (see FIG. 12a), in which the projection 150 on the outer race 130 is positioned in the slot 242 to allow the inner race 126 to rotate about the central axis 26 in any direction relative to the outer race 130. As shown in FIG. 11, a wave spring 250 may be used to bias the control member 230 with respect to the inner and outer races 126, 130 such that the control member 230 is retained in one of the positions B and C.

Like the control member 206 of FIGS. 9-10b, the control member 230 of FIGS. 11-12b is movable along the central axis 26 relative to the inner and outer races 126, 130 to position B to operate the clutch 226 in the one-way lock mode and position C to operate the clutch 226 in the full-lock mode. The interaction of the projections 146, 150 on the inner and outer races 126, 130 and the control member 230 in the one-way lock mode and the full-lock mode is substantially similar to that of the control members 154, 182, 206 of FIGS. 7a-7d, FIGS. 8a-8d, and FIGS. 10a-10b and will not be discussed again in detail.

Various configurations may be utilized to axially retain the outer race 130 relative to the output member 18. For example, as shown in FIGS. 9 and 11, a nib 254 of the output member 18 may be peened radially inwardly to axially retain the outer race 130 relative to the output member 18. Also, as shown in FIG. 11, another nib 258 may be peened radially inwardly to axially retain the spring 250. Other configurations and retaining means may also be utilized.

The clutches 10, 102, 122 of FIGS. 1-8d may be used in the driveline of a secondary axle for driving, for example, the front wheels in a four wheel drive (“4 WD”) vehicle. In such a 4 WD vehicle, the clutches 10, 102, 122 may be adjusted to the no-lock mode corresponding with position A to operate the vehicle in two wheel drive (“2 WD”) mode. In the no-lock mode, no torque may be transferred through the clutches 10, 102, 122 to the secondary axle.

To operate the vehicle in “all-purpose” or “full-time” 4 WD forward drive, the clutches 10, 102, 122 may be adjusted to the one-way lock mode corresponding with position B. The secondary axle typically has a higher numerical ratio than the primary (i.e., rear) axle, such that the input driveshaft to the secondary axle rotates at a higher speed than the input driveshaft to the primary axle. The clutches 10, 102, 122, operating in one-way lock mode, do not allow torque transfer to the input driveshaft of the secondary axle during good traction conditions. However, when the rear wheels slip, the vehicle slows down and so does the input driveshaft to the secondary axle. Torque may then be transferred to the input driveshaft of the secondary axle, and subsequently to the front wheels, when the input driveshaft of the secondary axle wants to rotate more slowly than the input driveshaft to the primary axle.

The clutches 10, 102, 122 may also be adjusted to the full-lock mode corresponding with either positions C or D to provide 4 WD forward-direction engine braking (i.e., “negative torque”). The clutches 10, 102, 122 are preferably adjusted to the closest position C or D to assure immediate lock. In other words, if the clutches 10, 102, 122 were operating in the no-lock mode corresponding with position A, the clutches 10, 102, 122 would be adjusted to the full-lock mode corresponding with position D. Likewise, if the clutches 10, 102, 122 were operating in the one-way lock mode corresponding with position B, the clutches 10, 102, 122 would be adjusted to the full-lock mode corresponding with position C.

The clutches 10, 102, 122 may also be adjusted to the no-lock mode corresponding with position A to provide reverse drive to avoid torque windup between the input driveshafts of the secondary and primary axles due to the difference in numerical ratios between the secondary and primary axles which would occur if the clutches 10, 102, 122 were adjusted to either one-way lock mode or full-lock mode. Shifting or adjusting the clutches 10, 102, 122 before motion reversal assures that tooth mesh will occur as direction is reversed.

The clutches 10, 102, 122 may also be adjusted to the full-lock mode corresponding with either positions C or D to provide 4 WD reverse drive in low traction conditions.

Various features of the invention are set forth in the following claims.

What is claimed is:

1. A selectable mode clutch adapted to selectively couple an input member and an output member, the selectable mode clutch comprising:
a first race coupled for rotation with the input member about a central axis, the first race including a first bearing surface having a plurality of axial ridges;
a second race including a second bearing surface in facing relationship with the first bearing surface, the second bearing surface having a plurality of axial ridges;
a projection integrally formed with one of the first and second races;
a plurality of rollers positioned between the first and second bearing surfaces, the rollers engaging the axial ridges on the first and second bearing surfaces to radially displace the second race relative to the first race upon relative rotation between the first race and the second race; and
a control member rotatable about the central axis, the control member including a first receiving portion and a second receiving portion, one of the control member and the projection being movable along the central axis relative to the other of the control member and the projection between a first position, in which the projection is positioned in the first receiving portion to operate the clutch in a first mode, and a second position, in which the projection is positioned in the second receiving portion to operate the clutch in a second mode different from the first mode.

2. The selectable mode clutch of claim 1, wherein the first receiving portion includes a first slot in the control member, and wherein the second receiving portion includes a second slot in the control member.

3. The selectable mode clutch of claim 1, wherein the control member is coupled for rotation with the input member.

4. The selectable mode clutch of claim 1, wherein the projection is positioned in the first receiving portion to lock together the first race and the second race for co-rotation in the first mode of operation.

5. The selectable mode clutch of claim 1, wherein the projection is positioned in the second receiving portion to allow the first race to rotate about the central axis in a single direction relative to the second race in the second mode of operation.

6. The selectable mode clutch of claim 1, wherein the one of the control member and the projection is movable along the central axis relative to the other of the control member and the projection to a third position, in which the first race is rotatable about the central axis in any direction relative to the second race to operate the clutch in a third mode of operation.

7. The selectable mode clutch of claim 6, wherein the control member includes a third receiving portion, and wherein the projection is positioned in the third receiving portion to operate the clutch in the third mode of operation.

8. The selectable mode clutch of claim 6, wherein the one of the control member and the projection is movable along the central axis relative to the other of the control member and the projection to a fourth position, in which the first race is rotatable about the central axis in any direction relative to the second race to operate the clutch in the third mode of operation.

9. The selectable mode clutch of claim 8, wherein the third position corresponds with an outermost position of the one of the control member and the projection in a first direction along the central axis, and wherein the fourth position corresponds with an outermost position of the one of the control member and the projection in a second direction along the central axis opposite the first direction.

10. The selectable mode clutch of claim 1, wherein the projection is a first projection on the second race extending radially inwardly, wherein the first race includes a second projection extending radially outwardly, and wherein the control member is movable along the central axis relative to the first projection and the second projection.

11. The selectable mode clutch of claim 10, wherein the first receiving portion of the control member includes a first slot having a width substantially equal to a width of the first projection, wherein the control member includes a second slot having a width substantially equal to a width of the second projection, and wherein the first projection is positioned in the first slot and the second projection is positioned in the second slot to operate the clutch in the first mode.

12. The selectable mode clutch of claim 11, wherein the second receiving portion of the control member includes a third slot having a width greater than the first slot, and wherein the first projection is positioned in the third slot and the second projection is positioned in the second slot to operate the clutch in the second mode.

13. The selectable mode clutch of claim 12, wherein the control member includes a fourth slot having a width greater than the third slot, and wherein the first projection is positioned in the fourth slot and the second projection is positioned in the second slot to operate the clutch in a third mode different from the second mode.

14. The selectable mode clutch of claim 12, wherein the first and third slots are defined by adjacent projections extending radially outwardly from the control member, wherein the first projection is positioned outside an axial extent of the projections on the control member, and wherein the second projection is positioned in the second slot to operate the clutch in a third mode different from the second mode.

15. The selectable mode clutch of claim 11, wherein the first projection is positioned in the first slot, and wherein the second projection is positioned outside an axial extent of the second slot to operate the clutch in a third mode different from the second mode.

16. The selectable mode clutch of claim 1, wherein the control member includes at least one cylindrical member having at least two different size slots formed therein.

17. The selectable mode clutch of claim 16, wherein the control member includes
a first cylindrical member having a first slot formed therein; and
a second cylindrical member having a second slot formed therein, the second slot being wider than the first slot.

18. The selectable mode clutch of claim 1, wherein the projection is a radially-extending projection.

19. A clutch assembly adapted to selectively couple an input member and an output member, the clutch assembly comprising:
a selectable mode clutch including
a first race coupled for rotation with the input member about a central axis, the first race including a first bearing surface having a plurality of axial ridges;
a second race including a second bearing surface in facing relationship with the first bearing surface, the second bearing surface having a plurality of axial ridges;
a projection integrally formed with one of the first and second races;
a plurality of rollers positioned between the first and second bearing surfaces, the rollers engaging the axial ridges on the first and second bearing surfaces to radially displace the second race relative to the first race upon relative rotation between the first race and the second race; and
a control member rotatable about the central axis, the control member including a first receiving portion and a second receiving portion; and
an actuator operable to move one of the control member and the projection along the central axis relative to the other of the control member and the projection between a first position, in which the projection is positioned in the first receiving portion to operate the clutch in a first mode, and a second position, in which the projection is positioned in the second receiving portion to operate the clutch in a second mode different from the first mode.

20. The clutch assembly of claim 19, wherein the first receiving portion includes a first slot in the control member, and wherein the second receiving portion includes a second slot in the control member.

21. The clutch assembly of claim 19, wherein the control member is coupled for rotation with the input member.

22. The clutch assembly of claim 19, wherein the projection is positioned in the first receiving portion to lock together the first race and the second race for co-rotation in the first mode of operation.

23. The clutch assembly of claim 19, wherein the projection is positioned in the second receiving portion to allow the first race to rotate about the central axis in a single direction relative to the second race in the second mode of operation.

24. The clutch assembly of claim 19, wherein the one of the control member and the projection is movable along the central axis relative to the other of the control member and the projection to a third position, in which the first race is rotatable about the central axis in any direction relative to the second race to operate the clutch in a third mode of operation.

25. The clutch assembly of claim 24, wherein the control member includes a third receiving portion, and wherein the projection is positioned in the third receiving portion to operate the clutch in the third mode of operation.

26. The clutch assembly of claim 24, wherein the one of the control member and the projection is movable along the central axis relative to the other of the control member and the projection to a fourth position, in which the first race is rotatable about the central axis in any direction relative to the second race to operate the clutch in the third mode of operation.

27. The clutch assembly of claim 26, wherein the third position corresponds with an outermost position of the one of the control member and the projection in a first direction along the central axis, and wherein the fourth position corresponds with an outermost position of the one of the control member and the projection in a second direction along the central axis opposite the first direction.

28. The clutch assembly of claim 18, wherein the projection is a first projection on the second race extending radially inwardly, wherein the first race includes a second projection extending radially outwardly, and wherein the control member is movable along the central axis relative to the first projection and the second projection.

29. The clutch assembly of claim 28, wherein the first receiving portion of the control member includes a first slot having a width substantially equal to a width of the first projection, wherein the control member includes a second slot having a width substantially equal to a width of the second projection, and wherein the first projection is positioned in the first slot and the second projection is positioned in the second slot to operate the clutch in the first mode.

30. The clutch assembly of claim 29, wherein the second receiving portion of the control member includes a third slot having a width greater than the first slot, and wherein the first projection is positioned in the third slot and the second projection is positioned in the second slot to operate the clutch in the second mode.

31. The clutch assembly of claim 30, wherein the control member includes a fourth slot having a width greater than the third slot, and wherein the first projection is positioned in the fourth slot and the second projection is positioned in the second slot to operate the clutch in a third mode different from the second mode.

32. The clutch assembly of claim 30, wherein the first and third slots are defined by adjacent projections extending radially outwardly from the control member, wherein the first projection is positioned outside an axial extent of the projections on the control member, and wherein the second projection is positioned in the second slot to operate the clutch in a third mode different from the second mode.

33. The clutch assembly of claim 29, wherein the first projection is positioned in the first slot, and wherein the second projection is positioned outside an axial extent of the second slot to operate the clutch in a third mode different from the second mode.

34. The clutch assembly of claim 19, wherein the actuator includes a shifter fork operable to move the one of the control member and the projection between the first position and the second position.

35. The clutch assembly of claim 34, further comprising a flange coupled for rotation with the one of the control member and the projection about the central axis, wherein the shifter fork engages the flange to move the one of the control member and the projection between the first position and the second position.

36. The clutch assembly of claim 19, wherein the actuator includes a solenoid operable to move the one of the control member and the projection between the first position and the second position.

37. The clutch assembly of claim 19, wherein the actuator includes an expandable hydraulic chamber operable to move the one of the control member and the projection between the first position and the second position.

38. The clutch assembly of claim 19, wherein the control member includes at least one cylindrical member having at least two different size slots formed therein.

39. The clutch assembly of claim 19, wherein the control member includes
a first cylindrical member having a first slot formed therein; and
a second cylindrical member having a second slot formed therein, the second slot being wider than the first slot.

40. The clutch assembly of claim 19, wherein the projection is a radially-extending projection.
